(19) United States
(12) Patent Application Publication
(10) Pub. No.: US 2015/0024628 A1
(43) Pub. Date: Jan. 22, 2015

(54) COAXIAL PLUG CONNECTOR ARRANGEMENT

(71) Applicant: Telegaertner Karl Gaertner GmbH, Steinenbronn (DE)

(72) Inventors: Werner Haegele, Stuttgart (DE); Reinhard Vogl, Steinenbronn (DE); Guenter Waeller, Waiblingen (DE)

(21) Appl. No.: 14/330,067

(22) Filed: Jul. 14, 2014

(30) Foreign Application Priority Data
Jul. 22, 2013 (DE) 10 2013 107 820

(51) Int. Cl. H01R 9/05

(52) U.S. Cl. CPC H01R 9/0524; H01R 9/05
USPC 439/585; 439/578

(57) ABSTRACT

A coaxial plug connector arrangement is provided, having an inner sleeve which is pluggable into an outer sleeve in an axial direction. The inner and outer sleeves have respective through openings for inserting first and second contact pins, respectively. A first insulating part is fixed to the inner sleeve. The two contact pins are connected together in an electrically conductive manner via an inner conductor part held on the first insulating part. In a plugged-in state, the inner sleeve is spaced at a distance from the outer sleeve in the axial direction. To provide low passive intermodulation, the inner sleeve rests in an electrically conductive manner against a single contact area disposed on an inner side of the outer sleeve which surrounds the inner sleeve in a circumferential direction. The outer sleeve is fixed via a second insulating part to the inner sleeve in an axially and radially immovable manner.

This application claims the benefit of German application number 10 2013 107 820.6 filed on Jul. 22, 2013, which is incorporated herein by reference in its entirety and for all purposes.

### BACKGROUND OF THE INVENTION

The invention relates to a coaxial plug connector arrangement, comprising an inner sleeve and an outer sleeve, the inner sleeve being pluggable into the outer sleeve in the axial direction and having a through opening for inserting a first contact pin, and the outer sleeve having a second through opening for inserting a second contact pin, and comprising a first insulating part which is fixed to the inner sleeve and on which an inner conductor part is held, the two contact pins being connectable to one another in an electrically conductive manner via the inner conductor part, and in the plugged-in state, the inner sleeve with its free end facing the outer sleeve being spaced at a distance from the outer sleeve in the axial direction.

By means of such coaxial connector arrangements, an electrical connection can be established between a first coaxial cable and a second coaxial cable. In the same manner, an electrical connection can also be established between a coaxial cable and another electrical assembly. An end region of the coaxial cable with its inner conductor, which forms a contact pin, can be passed through the first through opening, and the inner conductor of another coaxial cable, which likewise forms a contact pin, can be correspondingly passed through the second through opening. The two contact pins may customarily be inserted into recesses in the inner conductor part, and may be electrically connected to one another via this inner conductor part. The outer conductors of the two coaxial cables can be electrically connected to the inner sleeve and the outer sleeve, respectively, for example by means of a solder joint, and the inner sleeve can subsequently be plugged into the outer sleeve so that the outer conductors of the coaxial cables are also connected to one another in an electrically conductive manner via the two sleeves. The sleeves thus form two outer conductor parts of the coaxial plug connector arrangements.

Coaxial plug connector arrangements of this kind are known to the person skilled in the art. It is important for the operating characteristics of the coaxial plug connector arrangements that preferably no passive intermodulation (PIM) occurs; that is, there is preferably no mutual interference of electric signals that are transmitted at different frequencies via the coaxial plug connector arrangements. The passive intermodulation is influenced, among other things, by the stability of the mechanical connection of the inner sleeve to the outer sleeve. It is therefore proposed in DE 10 2011 056 466 A1 to dispose the inner sleeve in the plugged-in state at an axial distance from the outer sleeve, and to provide electrical contacting between the inner sleeve and the outer sleeve only in the radial direction, namely, on the one hand via an annular bead disposed at the free end of the inner sleeve, and on the other hand via a radial widening of the inner sleeve disposed at a distance from the annular bead. The radial widening at the same time is used for establishing a detent connection between the inner sleeve and the outer sleeve, in that an annular groove is disposed in the region of the radial widening, into which a ring-shaped detent projection of the outer sleeve extends.

It is an object of the present invention to improve a coaxial plug connector arrangement of the kind stated at the outset, in such a manner that it has particularly low passive intermodulation.

### SUMMARY OF THE INVENTION

For a coaxial plug connector arrangement of the generic kind, this object is achieved in that the inner sleeve rests in an electrically conductive manner against a single contact area of the outer sleeve, the contact area being disposed on an inner side of the outer sleeve and surrounding the inner sleeve in the circumferential direction, and the free end of the outer sleeve facing the inner sleeve being fixed via a second insulating part to the inner sleeve in an axially and radially immovable manner.

In the coaxial plug connector arrangement according to the invention, the inner sleeve extends into the outer sleeve, the inner sleeve contacting the outer sleeve only at a single contact area. This contact area surrounds the inner sleeve in the circumferential direction so that the inner sleeve contacts the outer sleeve in the radial direction. There is no axial contacting of the inner sleeve with the outer sleeve. With the exception of the contact area surrounding the inner sleeve in the circumferential direction, the inner sleeve contacts the outer sleeve in no other region. To avoid an axial or radial movement of the outer sleeve relative to the inner sleeve, a second insulating part is used via which the free end of the outer sleeve facing the inner sleeve is fixed to the inner sleeve in an electrically insulating manner. The fixing of the outer sleeve to the inner sleeve is thus carried out via an electrically insulating part which only ensures mechanical arresting of the outer sleeve on the inner sleeve, but prevents an electrically conductive connection of the outer sleeve to the inner sleeve in the region of the free end of the outer sleeve.

The coaxial plug connector arrangement according to the invention is characterized by extremely low passive intermodulation, and at the same time, by high mechanical stability.

The contact area extending over the outer periphery of the inner sleeve is advantageously configured as a cylindrical wall portion of the outer sleeve.

In an advantageous embodiment of the invention, a wall portion of the outer sleeve that conically widens toward the free end of the outer sleeve is connected to the cylindrical wall portion of the outer sleeve, the inner sleeve extending into the conically widening wall portion, and the conically widening wall portion and the inner sleeve defining an annular chamber between them.

A cylindrical end portion may adjoin the conically widening wall portion of the outer sleeve in the direction of the free end of the outer sleeve.

In an advantageous embodiment of the invention, the outer sleeve has a rigid design, so that it cannot be deformed in the radial direction during assembly of the coaxial plug connector.

As already mentioned, radial and axial fixing of the outer sleeve to the inner sleeve is carried out by means of the second insulating part. It is advantageous if the outer sleeve is non-rotatably held on the inner sleeve by means of the second insulating part. In such an embodiment of the invention, in the assembled state of the coaxial plug connector, the outer sleeve cannot be moved relative to the inner sleeve in the radial or the axial direction, and a rotational movement of the outer sleeve relative to the inner sleeve is not possible. Corresponding movements are reliably prevented by providing the second insulating part.

The second insulating part advantageously extends over the outer periphery of the inner sleeve and the outer sleeve. It can in particular be provided that the second insulating part completely surrounds the inner sleeve and the outer sleeve in the region adjacent to the free end of the outer sleeve.

On its rear side facing away from the outer sleeve, the inner sleeve advantageously has a collar which protrudes beyond the second insulating part in the axial direction, and which accommodates an end region of a coaxial cable.

On its rear side facing away from the inner sleeve, the outer sleeve preferably has a collar which protrudes beyond the second insulating part and which likewise accommodates an end region of a coaxial cable.

The collar-shaped end region of the inner sleeve and/or the collar-shaped end region of the outer sleeve can have a receiving chamber in which a solder preform can be positioned for soldering the coaxial cable to the corresponding sleeve.

In an advantageous embodiment of the invention, the second insulating part can be press-fitted to the outer sleeve and to the inner sleeve. The press-fit connection of the second insulating part to the outer sleeve on the one hand, and to the inner sleeve on the other hand, allows a mechanically durable fixation of the outer sleeve on the inner sleeve via the second insulating part, using a simple design.

It is advantageous if the second insulating part forms a clamping sleeve into which the outer sleeve and the inner sleeve can be pressed.

The clamping sleeve can advantageously be pressed onto the outer sleeve and onto the inner sleeve in the axial direction. This makes it possible to slip the clamping sleeve onto a coaxial cable prior to assembling the coaxial plug connector arrangement, to subsequently connect the coaxial cable, via the two sleeves, and the inner conductor, in an electrically conductive manner, to a second coaxial cable or another electrical module that has a contact pin, the inner sleeve being plugged into the outer sleeve, and to subsequently press the clamping sleeve onto the inner sleeve and the outer sleeve in the axial direction in order to thus axially and radially fix the outer sleeve to the inner sleeve via the clamping sleeve.

It is advantageous when the second insulating part can be detachably connected to the outer sleeve and/or the inner sleeve. This allows the connection between the outer sleeve and the inner sleeve to be disconnected once again, if needed.

In an advantageous embodiment, the second insulating part can be detachably locked to the outer sleeve and/or the inner sleeve.

It can be provided that the second insulating part can be screwed to the outer sleeve and/or the inner sleeve.

It is advantageous when the second insulating part can be detachably connected to the outer sleeve and/or the inner sleeve without a tool. This allows particularly simple handling of the coaxial plug connector arrangement.

As already mentioned, in the plugged-in state the inner sleeve with its free end facing the outer sleeve is spaced at a distance from the outer sleeve in the axial direction. To reliably avoid unintentional contacting of the inner sleeve with the outer sleeve, it is advantageous when, in the plugged-in state of the inner sleeve, the first insulating part rests against the outer sleeve with a front stop surface which protrudes beyond the free end of the inner sleeve in the axial direction. This ensures that during insertion of the inner sleeve into the outer sleeve, the first insulating part, which is fixed to the inner sleeve and protrudes beyond the free end of the inner sleeve in the axial direction, abuts against the outer sleeve, for example at a bottom wall of the outer sleeve, even before the free end of the inner sleeve can contact the outer sleeve in the axial direction.

It is particular advantageous when the outer sleeve can be acted on with an axial tensile force in the direction of the first insulating part by means of the second insulating part. In such a configuration, the second insulating part thus pulls the outer sleeve against the front stop surface of the first insulating part.

The first insulating part can rest against the inner sleeve, preferably on a bottom wall of the inner sleeve, with a rear stop surface which faces away from the outer sleeve. In such a configuration, the first insulating part is clamped between the inner sleeve and the outer sleeve under the action of an axial tension force of the second insulating part. This increases the mechanical durability of the coaxial plug connector arrangement.

The second insulating part can advantageously be placed against a radially oriented step of the outer sleeve and/or the inner sleeve. For example, it can be provided that the inner sleeve has a radially outwardly facing step against which the second insulating part can be placed. The radially outwardly facing step thus forms a stop surface for the second insulating part.

It is particularly advantageous when the second insulating part has a spacer element that can be inserted between the free end of the outer sleeve and the inner sleeve. The spacer element thus occupies a position between the free end of the outer sleeve and the inner sleeve, and thereby ensures that the outer sleeve cannot unintentionally directly contact the inner sleeve in this region.

The spacer element is advantageously formed as an annular collar that is surrounded by a sheath of the second insulating part, forming an annular chamber, it being possible to press a free end portion of the outer sleeve into the annular chamber in the axial direction, and to press a portion of the inner sleeve into the collar. The collar can be placed against the inner sleeve under plastic and/or elastic deformation, and at the same time the sheath can be placed against the outer sleeve under elastic and/or plastic deformation, the outer sleeve extending with a free end portion into the annular chamber between the sheath and the collar. This results in particularly high mechanical durability of the coaxial plug connector arrangement, it being possible to fix the outer sleeve to the inner sleeve using a simple design, and at the same time to ensure that the outer sleeve electrically contacts the inner sleeve only in a contact area that extends over the outer periphery of the inner sleeve.

The second insulating part preferably has a rigid clamping portion which surrounds the outer sleeve and the inner sleeve in the circumferential direction, and which in the axial direction is adjoined by an elastically deformable connecting portion for establishing a detachable connection to the outer sleeve. The rigid clamping portion ensures that the outer sleeve can be fixed to the inner sleeve in an axially and radially immovable manner, and the connecting portion adjoining the clamping portion the axial direction allows a detachable connection of the second insulating part to the outer sleeve, using a simple design.

The connecting portion advantageously has a plurality of flexible tongues that are elastically deformable in the radial direction.

Such flexible tongues are particularly advantageous in providing a detent connection between the second insulating part and the outer sleeve. For this purpose, it can be provided that the flexible tongues each carry a first detent element at their free end which interacts with a detent element of the outer sleeve having a complementary configuration.

In its end region facing away from the inner sleeve, the outer sleeve advantageously carries detent toothing on the outer side which interacts with the detent teeth of the second insulating part having a complementary configuration.

The first insulating part and the second insulating part are preferably made of the same plastics material, for example a polytetrafluoroethylene material.

The following description of two preferred embodiments of the invention provides more detailed explanation, with reference to the drawing.

### BRIEF DESCRIPTION OF THE DRAWINGS

FIG. 1 shows a schematic cross-sectional view of a first embodiment of a coaxial plug connector arrangement for establishing an electrical and mechanical connection between two coaxial cables;

FIG. 2: shows a perspective illustration of the coaxial plug connector arrangement from FIG. 1;

FIG. 3 shows a perspective, partially separated illustration of the coaxial plug connector arrangement from FIG. 1, in the manner of an exploded drawing, and

FIG. 4 shows a schematic sectional view of a second embodiment of a coaxial plug connector arrangement for establishing an electrical and mechanical connection between two coaxial cables.

### DETAILED DESCRIPTION OF THE INVENTION

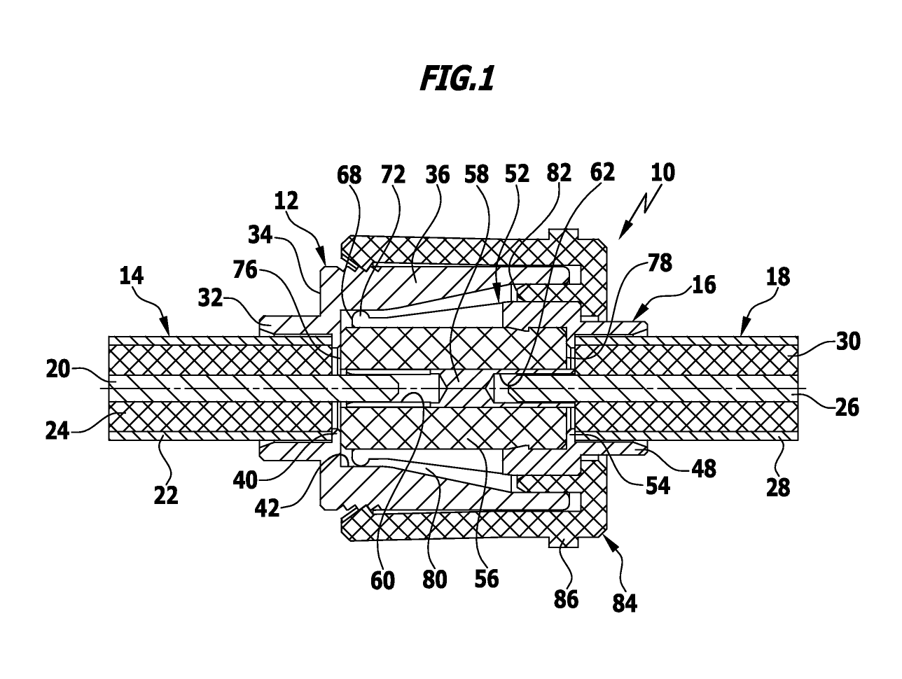

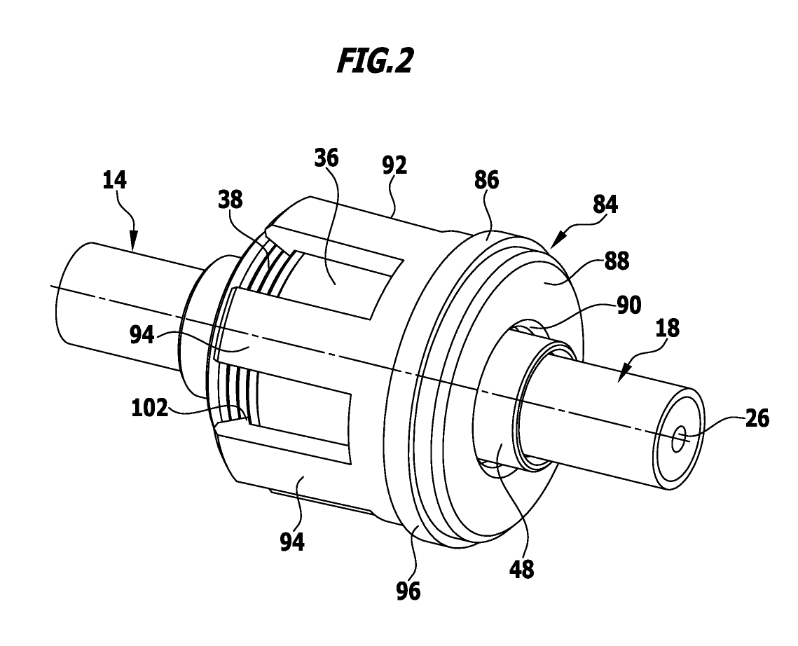

FIGS. 1 to 3 schematically illustrate a first embodiment of a coaxial plug connector arrangement according to the invention, designated overall by reference numeral 10. The coaxial plug connector arrangement 10 comprises an outer sleeve 12 to which a first coaxial cable 14 is connected, and an inner sleeve 16 to which a second coaxial cable 18 is connected. The two coaxial cables 14, 18 can be electrically and mechanically connected to one another and disconnected from one another, if needed, by means of the coaxial plug connector arrangement 10.

The first coaxial cable 14 customarily includes an inner conductor 20 and an outer conductor 22, between which a dielectric 24 is situated. The second coaxial cable 18 includes an inner conductor 26 and an outer conductor 28, between which a dielectric 30 is situated.

On its rear side facing away from the inner sleeve 16, the outer sleeve 12 has a collar-shaped first sleeve portion 32 that transitions via a radially outwardly directed step 34 into a second sleeve portion 36 which on its outer side carries detent toothing 38 adjacent to the step 34. The detent toothing 38 extends over the complete outer periphery of the second sleeve portion 36.

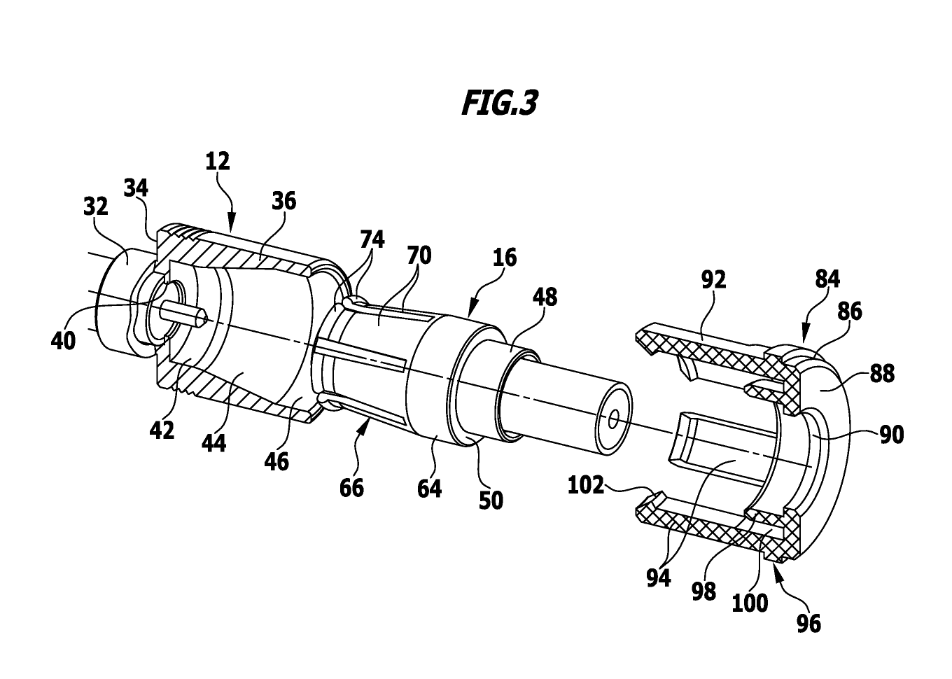

Axially in the direction of the inner sleeve 16, offset with respect to the step 34, the outer sleeve 12 has a radially inwardly facing inner shoulder 40, which on the inner side of the second sleeve portion 36 is adjoined by a circular cylindrical rear wall portion 42 at the level of the detent toothing 34, the rear wall portion transitioning into a circular cylindrical front wall portion 46 via a conically widening middle portion 44. This is also apparent in particular from FIG. 3.

The first coaxial cable 14 together with the exposed outer conductor 22 can be inserted into the collar-shaped first sleeve portion 32 until the outer conductor 22 and the dielectric 24 come into contact with the inner shoulder 40. The exposed inner conductor 20 of the first coaxial cable 14 forms a contact pin that extends into the interior of the outer sleeve 12 which is surrounded by the second sleeve portion 36.

On its rear side facing away from the outer sleeve 12, the inner sleeve 16 has a collar-shaped first sleeve portion 48 that transitions into a second sleeve portion 52 via a radially outwardly directed step 50. An inner shoulder 54 protrudes radially inwardly in the transition region between the first sleeve portion 48 and the second sleeve portion 52.

The second sleeve portion 52 surrounds a first insulating part 56 that has a central through hole in which an electrically conductive inner conductor part 58 is situated. The inner conductor part 58 has a first blind hole-like recess 60 that faces the first coaxial cable 14, and the inner conductor part 58 has a blind hole-like second recess 62 that faces the second coaxial cable 18.

The second coaxial cable 18 together with the exposed outer conductor 28 can be inserted into the first sleeve portion 48 of the inner sleeve 16 until the outer conductor 28 and the dielectric 30 come into contact with the inner shoulder 54. The exposed inner conductor 26 of the second coaxial cable 18 forms a contact pin that can extend into the second recess 62 of the inner conductor part, thereby establishing an electrical and mechanical connection to the inner conductor 58.

It can be provided that a receptacle for a solder preform is situated in the region of the second recess 62 so that the inner conductor 26 of the second coaxial cable 18, after the inner conductor has been inserted into the second recess 62, can be soldered to the inner conductor part 58 under the action of heat.

The second sleeve portion 52 of the inner sleeve 16 has a cylindrical holding portion 64 which directly adjoins the step 50 in the direction facing away from the first sleeve portion 48. A connecting portion 66 adjoins the holding portion 64 in the direction facing away from the first sleeve portion 48, and conically narrows toward the free end 68 of the inner sleeve 16, forming a plurality of flexible tongues 70 that are elastically deformable in the radial direction.

In the plugged-in state, the free end 68 of the inner sleeve 16 occupies a position at the level of the circular cylindrical rear wall portion 42 of the outer sleeve 12. In this region, the inner sleeve 16 has an annular bead 72 which extends over the outer periphery of the inner sleeve 16 and which is formed by individual annular bead portions 74, each being situated on a flexible tongue 70.

As is apparent in particular from FIG. 1, the first insulating part 56 protrudes beyond the free end 68 of the inner sleeve 16 in the axial direction. In the plugged-in state, the first insulating part 56 rests with a front stop surface 76 against the inner shoulder 40 of the outer sleeve 12. Correspondingly, a rear stop surface 78 of the first insulating part 56 facing the second coaxial cable 18 rests against the inner shoulder 54 of the inner sleeve 14.

The first insulating part 56, which protrudes beyond the free end 68 of the inner sleeve 16, ensures that in the plugged-in state the inner sleeve 16 can electrically contact the outer sleeve 12 only in the region of the cylindrical rear wall portion 42, but that electrical contacting in the axial direction is prevented.

In the plugged-in state, a first annular chamber 80 extends between the connecting portion 66 of the inner sleeve 16 and the middle portion 44 of the outer sleeve 12, and a second annular chamber 82 extends in the region between the holding portion 64 of the inner sleeve 16 and the circular cylindrical front wall portion 46 of the outer sleeve 12.

Fixing the outer sleeve 12 to the inner sleeve 16 in the coaxial plug connector arrangement 10 illustrated in FIGS. 1 to 3 is carried out by means of a second insulating part 84 that is made of the same plastics material as the first insulating part 56, preferably a polytetrafluoroethylene material.

The second insulating part 84 is provided in the form of a clamping sleeve 86 that has a base 88 with a central opening 90. The outer periphery of the base 88 is adjoined in the axial direction by a sheath 92 which in its end region facing the detent toothing 38 of the outer sleeve 12 is formed by a multiplicity of flexible tongues 94. At the level of the holding portion 64 of the inner sleeve 16, the sheath 92 in combination with the base 88 forms a clamping part 96 which, in addition to the end portion of the sheath 92 facing the base 88 and the base 88, has a collar 98 which protrudes from the base 88 in the axial direction and is surrounded by the sheath 92. An annular chamber 100 extends between the collar 98 and the sheath 92.

For establishing a mechanical and electrical connection of the first coaxial cable 14 to the second coaxial cable 18, in first instance the first coaxial cable 14 can be soldered to the outer sleeve 12, the inner conductor 20 of the first coaxial cable 14 extending into the interior of the outer sleeve 12.

Correspondingly, the second coaxial cable 18 can be soldered to the inner sleeve 16, whereby the inner conductor 26 of the second coaxial cable 18 extends into the second recess 62 of the inner conductor part 58 and can be soldered thereto. The inner sleeve 16 can be subsequently plugged into the outer sleeve 12, the inner conductor 26 of the first coaxial cable 14 extending into the first recess 60 in the inner conductor part 58. The inner conductor 20 of the first coaxial cable 14 can also be soldered to the inner conductor part 58 by means of a suitable solder deposit.

To subsequently fix the outer sleeve 12 to the inner sleeve 16 in an axially and radially immovable manner, in a further assembly step the clamping sleeve 86, which has been attached to the second coaxial cable 18 beforehand, can be moved far enough in the axial direction that the collar 98 of the clamping part 96 extends into the second annular chamber 82 between the holding portion 64 of the inner sleeve 16 and the circular cylindrical front wall portion 46 of the outer sleeve 12, at the same time the sheath 92 surrounding the second sleeve portion 36 of the outer sleeve 12 and locking with the outer sleeve 12. For this purpose, the flexible tongues 94 of the sheath 92 carry detent projections 102 on their inner side facing the outer sleeve 12, which interact with the detent toothing 38 for establishing a detent connection.

The clamping sleeve 86 is pressed with its collar 98 onto the holding portion 64 of the inner sleeve 16, and the sheath 92 is pressed onto the outer sleeve 12 in the region of the clamping part 96. The clamping sleeve 86 thus rests against the radially outwardly directed step 50 of the inner sleeve 16 in the region of the base 88, and exerts an axially directed tensile force on the outer sleeve 12 in the direction of the inner sleeve 16. As a result, the first insulating part 56 is clamped with its stop surfaces 76 and 78 between the outer sleeve 12 and the inner sleeve 16.

Due to providing the clamping sleeve 86, the outer sleeve 12 is held against the inner sleeve 16 in an axially and radially immovable manner, and a rotational movement of the outer sleeve 12 about the inner sleeve 16 is also reliably prevented by means of the clamping sleeve 86.

The electrical and mechanical contacting of the inner sleeve 16 with the outer sleeve 12 takes place only in the region of the annular bead 72, which contacts the circular cylindrical rear wall portion 42 in the radial direction. The circular cylindrical rear wall portion 42 forms the sole contact area of the outer sleeve 12 against which the inner sleeve 16 rests in an electrically conductive manner. In combination with the axial and radial and non-rotatable fixation of the outer sleeve 12 on the inner sleeve 16, this ensures that practically no passive intermodulation occurs in the coaxial plug connector arrangement 10. The coaxial plug connector arrangement 10 is thus characterized by very good electrical transmission properties.

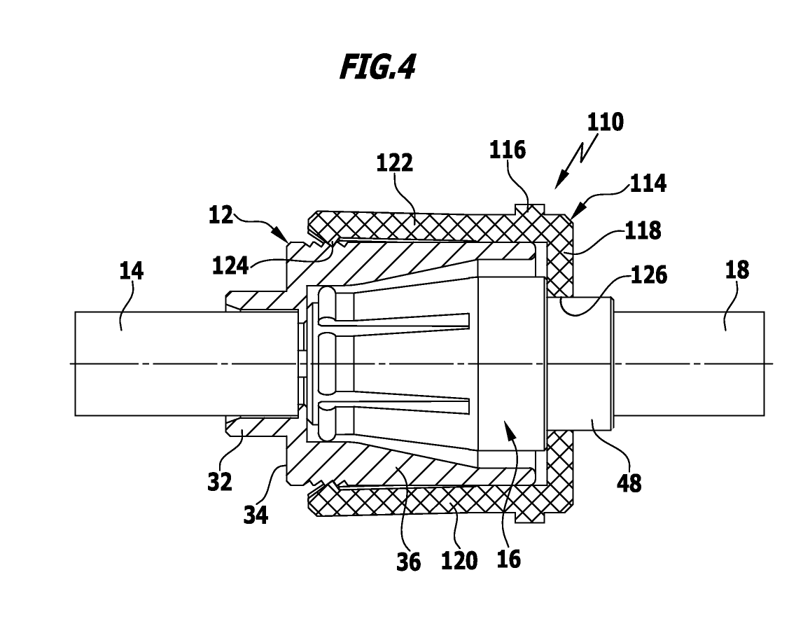

FIG. 4 schematically illustrates a second advantageous embodiment of a coaxial plug connector arrangement according to the invention, designated overall by reference numeral 110. The coaxial plug connector arrangement 110 is largely identical to the coaxial plug connector arrangement 10 explained above with reference to FIGS. 1 to 3. Thus, for identical components, the same reference numerals are used in FIG. 4 as in FIGS. 1 to 3, and reference is made to the above explanations in order to avoid repetition with regard to these components.

The coaxial plug connector arrangement 110 illustrated in FIG. 4 differs from the coaxial plug connector arrangement 10 in that, instead of the second insulating part 84 which has a collar, a second insulating part 114 is used which forms a clamping sleeve 116 without such a collar. The clamping sleeve 116 has a base 118 whose outer periphery is adjoined by a sheath 120 in the axial direction. Analogously to the sheath 92 of the clamping sleeve 84, the sheath 120 of the clamping sleeve 116 also has a plurality of flexible tongues 122 that carry detent projections 124 at their free ends, facing the outer sleeve 12.

Another difference between the above-explained second insulating part 84 and the second insulating part 114 illustrated in FIG. 4 is that the base 118 of the clamping sleeve 116 has a central opening 126, the diameter of which is smaller than the diameter of the opening 90 of the clamping sleeve 86. The diameter of the opening 126 is selected such that in the region of the base 118, the clamping sleeve 116 can be clamped to the first sleeve portion 48 of the inner sleeve 16.

In contrast to the clamping sleeve 86, the clamping sleeve 116 has no collar. However, during mounting of the clamping sleeve 116 on the outer sleeve 12, the sheath 120 is clamped to the outer sleeve 12 so that for the clamping sleeve 116, on the one hand a clamping connection with the outer sleeve 12, and on the other hand a clamping connection with the inner sleeve 16, are ensured. For the coaxial plug connector arrangement 110 as well, these clamping connections allow the outer sleeve 12 to be fixed to the inner sleeve 16 so as to be immovable in the axial and radial directions, a rotational movement of the outer sleeve 12 relative to the inner sleeve 16 also being prevented by means of the clamping sleeve 116.

The coaxial plug connector arrangement 110 as well is characterized by extremely low passive intermodulation, and can be produced in a cost-effective manner.

1. A coaxial plug connector arrangement, comprising an inner sleeve and an outer sleeve, the inner sleeve being pluggable into the outer sleeve in the axial direction and having a through opening for inserting a first contact pin, and the outer sleeve having a second through opening for inserting a second contact pin, and comprising a first insulating part which is fixed to the inner sleeve and on which an inner conductor part is held, the two contact pins being connectable to one another in an electrically conductive manner via the inner conductor part, and in the plugged-in state, the inner sleeve with its free end facing the outer sleeve being spaced at a distance from the outer sleeve in the axial direction, wherein the inner sleeve rests in an electrically conductive manner against a single contact area of the outer sleeve, the contact area being disposed on an inner side of the outer sleeve and surrounding the inner sleeve in the circumferential direction, and the free end of the outer sleeve facing the inner sleeve being fixed via a second insulating part to the inner sleeve in an axially and radially immovable manner.

2. The coaxial plug connector arrangement according to claim 1, wherein the outer sleeve is non-rotatably held on the inner sleeve by means of the second insulating part.

3. The coaxial plug connector arrangement according to claim 1, wherein the second insulating part extends over the outer periphery of the inner sleeve and the outer sleeve.

4. The coaxial plug connector arrangement according to claim 1, wherein the second insulating part is adapted to be press-fitted to the outer sleeve and to the inner sleeve.

5. The coaxial plug connector arrangement according to claim 1, wherein the second insulating part forms a clamping sleeve into which the outer sleeve and the inner sleeve can be pressed.

6. The coaxial plug connector arrangement according to claim 5, wherein the clamping sleeve is adapted to be pressed onto the outer sleeve and the inner sleeve in the axial direction.

7. The coaxial plug connector arrangement according to claim 1, wherein the second insulating part is adapted to be detachably connected to the outer sleeve and/or to the inner sleeve.

8. The coaxial plug connector arrangement according to claim 1, wherein the second insulating part is adapted to be detachably locked to the outer sleeve and/or the inner sleeve.

9. The coaxial plug connector arrangement according to claim 1, wherein in the plugged-in state of the inner sleeve, the first insulating part rests against the outer sleeve with a stop surface which protrudes beyond the free end of the inner sleeve in the axial direction, and the outer sleeve is adapted to be acted on with an axial tensile force in the direction of the first insulating part by means of the second insulating part.

10. The coaxial plug connector arrangement according to claim 1, wherein the second insulating part is adapted to be placed against a radially oriented step of the outer sleeve and/or the inner sleeve.

11. The coaxial plug connector arrangement according to claim 1, wherein the second insulating part has a spacer element adapted to be inserted between the free end of the outer sleeve and the inner sleeve.

12. The coaxial plug connector arrangement according to claim 11, wherein the spacer element forms an annular collar that is surrounded by a sheath of the second insulating part, forming an annular chamber, it being possible to press a free end portion of the outer sleeve into the annular chamber in the axial direction, and to press a portion of the inner sleeve into the collar.

13. The coaxial plug connector arrangement according to claim 1, wherein the second insulating part has a rigid clamping portion which surrounds the outer sleeve and the inner sleeve in the circumferential direction, and which in the axial direction is adjoined by an elastically deformable connecting portion in the axial direction for establishing a detachable connection to the outer sleeve.

14. The coaxial plug connector arrangement according to claim 13, wherein the connecting portion has a plurality of flexible tongues that are elastically deformable in the radial direction.

15. The coaxial plug connector arrangement according to claim 1, wherein the first and the second insulating parts are made of the same plastics material.
